(19) United States
(12) Patent Application Publication
(10) Pub. No.: US 2025/0268232 A1
(43) Pub. Date: Aug. 28, 2025

(54) DOG SQUEAKER BLADDER

(71) Applicants: Daniel Fiorica, North Brunswick, NJ (US); Alexia Merlo, Old Bridge, NJ (US)

(72) Inventors: Daniel Fiorica, North Brunswick, NJ (US); Alexia Merlo, Old Bridge, NJ (US)

(21) Appl. No.: 18/586,911

(22) Filed: Feb. 26, 2024

(51) Int. Cl. A01K 15/02

(52) U.S. Cl. CPC A01K 15/026

(57) ABSTRACT

A dog toy is configured with a digestible squeaker bladder. The dog toy includes a dog toy body; and a squeaker bladder configured for insertion into the dog toy body to generate a squeak sound when compressed. The squeaker bladder has a bladder body and an airport with a reed element arranged at an opening in the bladder body that allows air into the bladder when the bladder body is relaxed and allows air to pass through the reed element and out the airport when compressed. The bladder body is formed from temperature-sensitive material that shrinks and/or collapses and/or breaks apart when subjected to a dog's body temperature if ingested in order that the shrunk and/or collapsed and/or broken-apart bladder will pass through and out the dog's digestive system.

### BACKGROUND OF THE INVENTION

The present invention relates broadly to dog toys and more specifically relates to a dog squeaker bladder for use with dog toys that emit various squeak sounds as the toy/bladder is squeezed, the dog squeaker bladder configured to be “passible” through and out a dog's alimentary canal if inadvertently consumed by the dog.

A significant issue in the pet toy industry is the ingestion of animal toys. Domestic pets, particularly dogs, love to chew on things. Dogs appear drawn to squeaker toys in particular, which include squeaker bladders. Squeaker toys are typically made out of a synthetic, oil-derived polyolefin material like low density/high density polyethylene (LDPE/HDPE) and polypropylene (PP).

Dogs have a tendency to chew on toys with bladders and bladders and which they at times consume. And consumption of dog toys by dogs, including those with squeaker bladders, frequently leads to medical complications, including surgical interventions, unhappy dogs and unhappy dog owners.

Two important factors are toughness and strength and rigidity/flexibility. functional squeakers will need to be flexible enough to bend when the toy is chewed, which is a measure of elastic modulus (i.e. stiffness of a material, glass has very high modulus, as it doesn't bend or stretch, while rubber has a low modulus). Functional squeakers need to be durable enough to undergo significant chewing while remaining functional, which would be a measure of toughness.

Various consumable dog toys are known to reflect attempts at dog toy designs that might somehow limit a dog's natural inclination to chew and wholly consume the dog toy. For example, U.S. Pat. No. 9,756,834 to Forsythe (the “834 patent) discloses a dog toy in which the outer cover, filling material, and squeaker may be edible. The outer cover may have a resealable opening for the owner or pet to access the squeaker and filling. The squeaker and filling can be replaced when eaten (Claims 1-2, 5; FIGS. 1-3, Elements 16, 18, 20, 26; FIG. 4, Elements 16, 28, 30; Column 3, Lines 19-27; Column 5, Lines 32-42).

The '834 patent does not teach or suggest that any of the outer cover 12, the noise making device 16 or filling material 14, outer casing 18, second chamber 24, reed 26 or squeaker housing 20 are frangible or otherwise deforms and/or reduces in size to facilitate passage through the dog's digestive tract.

U.S. Pat. No. 9,737,052 to Larson (The '052 patent) discloses a dog toy with a digestible squeaker inserted into a larger plush toy that may or may not be digestible. In some configurations, the pet toy may house multiple noise emitters to produce a variety of sounds (Claims 1, 11; FIG. 1; Column 6, Lines 22-26)

The '052 patent does not teach or suggest that the body 12 is frangible, and while col. 3, line 44 indicates that the body can be digestible, nowhere does the '052 patent suggest that the noise making device 16, bladder 20 and/or other components may be made of temperature sensitive material.

U.S. Pat. No. 9,554,560 to Crumlin (the '560 patent”) discloses a squeak toy comprising a seal designed to break when a certain magnitude of force or deformation is acted on the shell, wherein a deterrent device may change the taste of the animal interaction device to one that is unpleasant to the animal like a bad tasting fluid such as the common Grannick's Bitter Apple fluid that is generally used to spray on objects to deter animals from chewing on the object (Claims 2, 4, and 15; FIG. 4; Column 6, Lines 39-49).

The '560 patent does not teach or suggest that the shell 120 contained within animal interaction device 110, or the interaction device are frangible, or digestible. Instead, a detection device 140 is included to detect when an animal chews through the shell at which time a deterrent device 150 is actuated to an “on” state during which a bad-tasting fluid is released. The point is to prevent the chewing animal, once it pierces the shell, from getting to a component 130 encapsulated in the shell that houses electronics or otherwise swallows.

US Published Appln. No. 2019/0373856 (the '856 application”) discloses a spherical pet toy with the ability to deliver an undesirable taste as a deterrent when damaged. The pet toy may include wireless communications hardware to alert owners when toy is damaged (Claims 1, 7-8; Paragraph [0015]). The '856 application does not teach that the body of toy 110 or toy cover 130 are frangible, or are digestible, or include a coating or is made of a material that tastes bad to deter consumption. Instead, the cover 130 includes an electrical grid 120, controlled by electronics 210, through which a current runs. If a dog sinks his/her teeth in the toy, its teeth contact the electrical grid. A detection device 140 triggers a deterrent device 150, which triggers a trickle current deters further chewing. (see par. 0013] and FIGS. 1 and 2 in particular.

### SUMMARY OF THE INVENTION

The present invention pertains to a novel and innovative dog squeaker bladder designed to be inserted into animal toys such as stuffed animal toys, and animal toys in which the dog squeaker bladder is included, which overcomes the shortcomings of the known art.

The inventive dog squeaker bladder is developed for insertion into dog toys, such as stuffed animal toys, so that if the dog toy is consumed, the dog squeaker bladder will be digestible and readily pass through and out the dog's alimentary canal, as its structure is formed with special material and configured with fault lines that act as structural weak points, e.g., scouring, so that the bladder breaks into pieces that also shrink at the dog's body temperature.

In an embodiment, the invention provides a squeaker bladder configured for insertion into animal toys to generate a squeak sound when compressed and/or relaxed after compression and configured to be pliable and/or frangible when contained within a digestive system of an animal that inadvertently consumes the squeaker bladder, or a portion of the squeaker bladder. The squeaker bladder comprises a bladder body; an airport with a squeaker arranged at an opening in the bladder body that allows air into the bladder when the bladder body is relaxed after compression and allows air to pass through the squeaker and out the airport when compressed.

The bladder body is formed from temperature-sensitive polymer that becomes pliable and/or collapses when subjected to an animal's body temperature upon ingestion to facilitate passing through and out the animal's digestive system. Preferably, the squeaker bladder is shaped spherically, or shaped cylindrically or pill-shaped. For that matter, the airport and squeaker are arranged at a spout arranged at said opening. And the body may include perforations that can operate as weak points to facilitate separations at the perforations when chewed.

The animal toy preferably is a dog toy. The bladder body can include a blend of radiopaque fillers, such as barium sulfate and/or bismuth, making them clearly visible under fluoroscopy and x-rays to enable tracking of the bladder body, or a portion of the bladder body within the dog's digestive track with an x-ray device. While these fillers could be applied as a coating, it is preferable that the fillers are mixed into the material from which the squeakers are formed, for example, the polymer materials in one embodiment.

Preferably, the bladder body includes a coating applied to the inside of the bladder that tastes terrible to dogs to act as a deterrent to further chewing on the bladder body once the outer perimeter is compromised. The bladder body may include a layer of non-toxic bittering substance, such as denatonium benzoate.

The bladder body also preferably includes pre-formed weakened perforations that facilitate a breakup of the bladder body along the perforations once ingested. The temperature-sensitive material facilitates the bladder collapse and passage through the animal's digestive tract. Preferably, the squeaker is a reed element.

In an embodiment, the dog toy is configured with a digestible squeaker bladder, the dog toy comprising: a dog toy body; a squeaker bladder configured for insertion into the dog toy body to generate a squeak sound when compressed, the squeaker bladder comprising: a bladder body; and an airport with a sound-emitting element arranged at an opening in the bladder body that allows air into the bladder when the bladder body is relaxed and allows air to pass through the sound e-emitting element and out the airport when compressed. Preferably, the bladder body is formed from temperature-sensitive material that becomes pliable and/or shrink in size (i.e., physical dimensions) when subjected to a dog's internal body temperature if ingested. Whether more pliable or diminished in size, those shrunken and/or more pliable parts of the bladder body or the bladder body will pass through and out the dog's digestive system. Put another way, the temperature-sensitive material from which the inventive bladder is formed collapses and/or shrinks and/or breaks up when subjected to the dog's internal temperature.

### BRIEF DESCRIPTION OF DRAWINGS

Further features and advantages of the invention will become apparent from the description of embodiments that follows, with reference to the attached figures, wherein:

FIG. 1A depicts an embodiment of the dog squeaker bladder of the invention that is conventionally spherically shaped, includes a spout, perforated failure points to impose a frangible character at the perforations and is made of body-safe temperature sensitive material that can physically shrink and/or deform and collapse at body temperatures;

FIG. 1B depicts a side view of the dog squeaker bladder of FIG. 1A;

FIG. 1C depicts the dog squeaker bladder of FIG. 1A in a separated and shrunken state after being subjected to the dog's internal temperature;

FIG. 1D depicts the dog after swallowing and digesting the dog squeaker to of FIG. 1A;

Fig. FIG. 2A depicts an embodiment of the dog squeaker bladder of the invention that is conventionally spherically shaped, does not include a spout but does include perforated failure points to impose a frangible character at the perforations and is made of body-safe temperature sensitive material that can physically shrink at body temperatures;

FIG. 2B depicts a side view of the dog squeaker bladder of FIG. 2A;

FIG. 2C depicts the dog squeaker bladder of FIG. 1A in a separated and shrunken state (preferably reduced state) after being subjected to the dog's internal temperature;

FIG. 2D depicts the dog after swallowing and digesting the dog squeaker to of FIG. 1A;

FIG. 3A depicts an embodiment of the dog squeaker bladder of the invention that is pill- or -cylindrically-shaped, does not include a spout but includes perforated failure points to impose a frangible character at the perforations and is made of body-safe temperature sensitive material that can physically shrink at body temperatures;

FIG. 3B depicts a side view of the dog squeaker bladder of FIG. 3A;

FIG. 3c depicts the dog squeaker bladder of FIG. 3A in a separated and shrunken state after being subjected to the dog's internal temperature;

FIG. 3D depicts the dog after swallowing and digesting the dog squeaker to of FIG. 3A; and

FIG. 4 depicts a teddy bear shaped dog toy, which includes a dog squeaker bladder such as that disclosed by FIGS. 1A. 1B, 1C.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art.

In its most basic form, the invention addresses a significant issue in the pet toy industry: the ingestion of toys and toys with squeaker bladders by dogs, which ingestion often leads to medical complications including at time the need for surgical intervention on the animal. The inventive dog squeaker bladder as now described, and toys within which the squeaker bladder is included, may be said to be a groundbreaking solution to the problem of dogs ingesting toys, particularly those dog toys with squeaker bladders. The inventive dog toy squeaker bladder, and dog toys in which the dog toy squeaker bladders are equipped comprise certain unique features that collectively mitigate the risks associated with squeaker bladder ingestion.

This innovative feature ensures that if the squeaker is ingested and subjected to dog body temperatures, which are about 100 degrees Fahrenheit, the structural integrity of the squeaker bladder collapses upon itself due to the temperatures in the dog's digestive system. The squeaker bladder may also be scoured to form perforations, at which perforations the bladder breaks up.

Preferably, the squeaker bladders of this invention, once internal and subjected to the internal temperature of the animal's body, such as a dog's stomach, will reduce in size and structure to pieces that are less than an inch in any 3D direction. This reduction in size and increased pliability facilitates safer passage through and out the dog's digestive system. For that matter, even if the bladder is swallowed in one piece, the temperature-sensitive material will reduce in size and thereby facilitate passage through and out the dog's digestive tract. The modulus of the temperature sensitive materials is the measure of stiffness or elasticity of the material. LDPE, HDPE, and PP have moduli in the range of 0.3-2.0 GPa. These ranges of stiffness and elasticity are preferred.

In an embodiment, the inventive squeaker bladders are manufactured using a material that is highly visible to X-rays, ensuring that any ingested squeaker can be readily detected by veterinarians during X-ray medical examinations. This material that is highly visible to x-rays could be added as a bladder coating, but preferably is included as a constituent in the material from which the inventive bladders are formed. While it would be unfortunate to be compelled to seek medical attention because a squeaker toy, etc. is stuck in the bowels of a beloved dog, there is relief in sight where the veterinarian or other animal health professional can see exactly where the mass of the collapsed squeaker bladder is in the dog's digestive system, to confirm that a foreign object is present and assess the need for surgical intervention, and/or to apply direct aid (e.g., during a simple fluoroscopic procedure).

Preferably, the inventive squeaker bladder also includes a recessed airport that is a specialized design to prevent the dog from accessing the squeaker's air chamber. In practice, including a recessed airport, rather than an airport that extends out and away from the outer surface of the squeaker bladder also is known to have an effect of deterring dogs from attempting to remove the squeaker bladder from the toy, or to ingest the squeaker bladder with the recessed airport if separated from the toy body. This also reduces the size of the bladder since no protrusion would exist, thus also not giving the dog an advantage of having a starting point to tear off. [[the spec should refer to many different embodiments and features where the claims is what defines the rights—not the spec]]

The dog squeaker bladder is crafted in a pill/tic tac shape. The tic-tac shape provides the squeaker bladder with a distinctive shape design that enhances its functionality and safety within animal toys in which they are arranged. And in another preferred form, the inventive dog squeaker bladder includes a dog-safe, non-toxic deterrent substance, such as denatonium benzoate. The dog-safe deterrent substance may be a coating on the squeaker bladder that tastes terrible to the dogs. By including the distasteful coating on the squeaker bladder, dogs are discouraged from attempting to further chew or swallow the toy configured with the inventive squeaker bladder. Put another way, this deterrent coating further reduces the likelihood of ingestion.

Another preferred feature of the inventive dog toy squeaker bladder is frangibility to support digestion and movement through the dog's digestive system if inadvertently consumed. That is, the dog squeaker bladder is designed to facilitate easy break apart along specifically perforated weak points located along the top and middle of the bladder in the exemplary embodiments. This frangible design ensures that if the squeaker bladder is swallowed, it will readily fragment into smaller, less obstructive pieces. The airport and source of the noise (squeaker element) may be designed to separate or to remain with the main body of the squeaker, as it moves through the dog's digestive system.

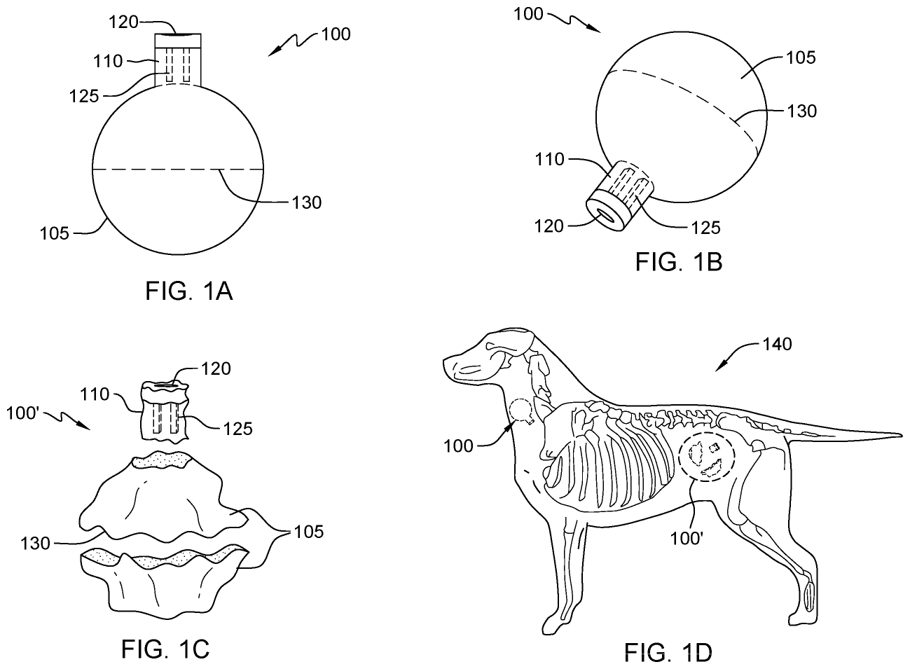

FIG. 1A depicts a first exemplary embodiment of the dog squeaker bladder 100 of the invention. Dog squeaker bladder 100 is conventionally spherically shaped, includes a spout 110 extending out from the body 105, an airport 120 through which the squeezed air exhales through reed element 125 to make a squeak (when compressed by a dog's jaws). The bladder inhales through the airport and reed upon release of squeezing (compression) pressure on the squeaker bladder. If the dog focuses his/her biting aggression on the squeaker toy with the squeaker bladder, the toy/bladder will come apart at perforated failure points 130. For that matter, the body 105 is made of body-safe temperature sensitive material that will begin to lose its shape and structural integrity at about 100 degrees Fahrenheit. Hence, once the frangible pieces are ingested and warm up to the dog's temperature, they become much more pliable and can collapse and shrink. The material also is readily digestible.

FIG. 1B depicts the squeaker bladder 100 of FIG. 1A in a side view, where FIG. 1C depicts the dog squeaker bladder in a separated and shrunken state, which separated and shrunken state of the squeaker bladder is identified as 100′ (after being subjected to the dog's internal temperature). FIG. 1D depicts the dog 140 after swallowing and digesting the dog squeaker, where a representation of the squeaker toy 100 is shown just below the dog's head in the left side of FIG. 1D and the digested, separated and collapsed dog squeaker bladder is shown encircled as element 100′ in FIG. 1D.

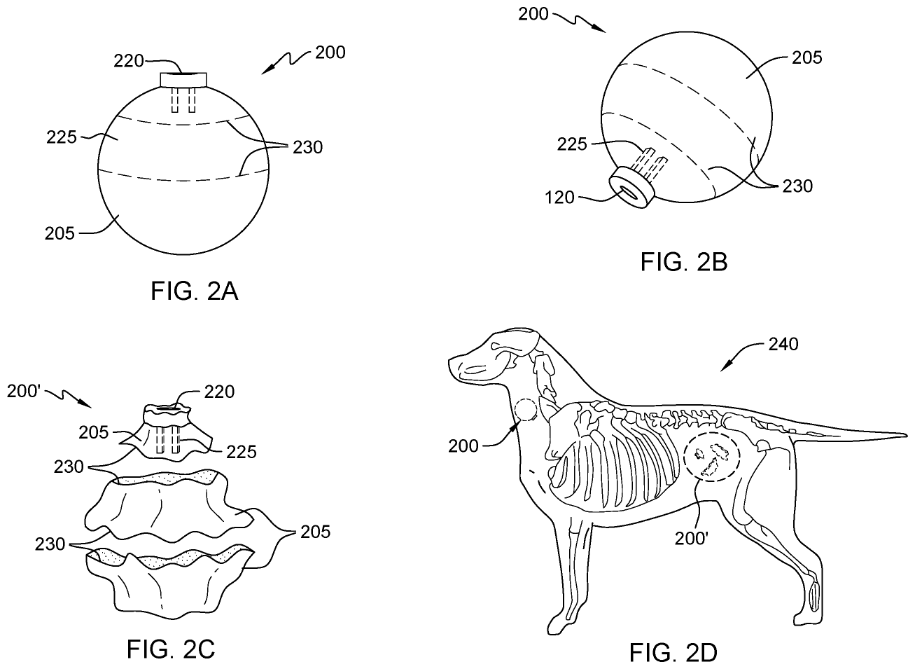

FIG. 2A depicts an embodiment of the dog squeaker bladder 200 of the invention that is conventionally spherically shaped, does not include a spout but does include an airport 220 and a reed element 225. The squeaker bladder body also includes perforated failure points 230 to realize a frangible character at the perforations and is made of body-safe temperature sensitive material (205) that becomes pliable at around 100 degrees Fahrenheit.

FIG. 2B depicts a side view of the dog squeaker bladder 200. FIG. 2C depicts the bladder in a separated and shrunken state (200′) after being subjected to the dog's internal temperature as it moves through the dog's alimentary canal. FIG. 2D depicts the dog 240 after swallowing and digesting the dog squeaker bladder, where a representation of the squeaker bladder 200 is shown just below the dog's head in the left side of FIG. 2D and the digested, separated and collapsed dog squeaker bladder is shown encircled as element 200′ in FIG. 2D.

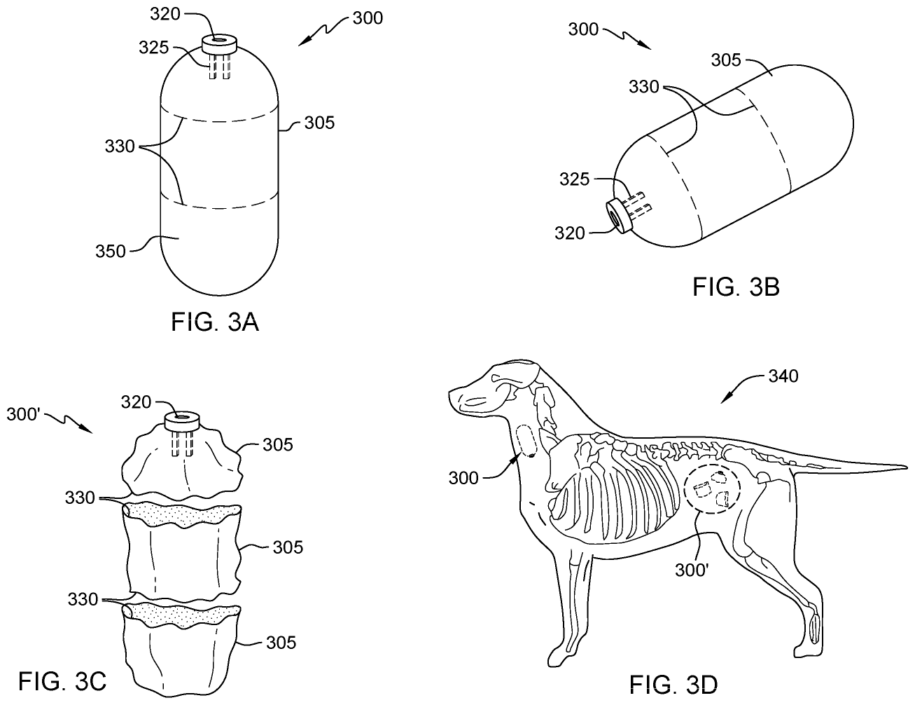

FIG. 3A depicts an embodiment of the dog squeaker bladder 300 of the invention that is pill- or -cylindrically-shaped, does not include a spout but includes an airport 320, and a reed element that makes a squeak when the bladder is compressed and air is exhaled through the reed element 225 and airport 200. The dog squeaker bladder also is formed with perforated failure points 330 to realize a frangible character at the perforations.

The squeaker bladder 300 is preferably made of body-safe temperature sensitive material 305 so that once within the dog's body, it will become pliable and preferably shrink and lose its shape. In one form, the inventive squeaker bladder includes a coating 350 that tastes terrible to dogs in an attempt to keep the dog from swallowing. FIG. 3B depicts a side view of the squeaker bladder 300. FIG. 3C depicts the bladder in a separated and shrunken state (300′) after being subjected to the dog's internal temperature as it moves through the dog's alimentary canal. FIG. 3D depicts the dog 340 after swallowing and digesting the dog squeaker bladder, where a representation of the squeaker bladder 300 is shown just below the dog's head in the left side of FIG. 3D and the digested, separated and collapsed dog squeaker bladder is shown encircled as element 200′ in FIG. 3D.

For large-scale production considerations, it is important that a dog squeaker material is thermoformable, or able to be heated above its melting temperature, molded into a shape, and cooled such that it retains the shape. For that matter, one embodiment relies upon a “sponge daddy” sponge as the squeaker bladder temperature sensitive material 306.

Scrub Daddy sponge is comprised of a mixture of polymers, or long-chained molecules. Further, it is likely polycaprolactone (pictured below) or some similar derivative thereof that is responsible for the hard-to-soft transition as the Scrub Daddy sponge is warmed. The effect that Scrub Daddy sponge exhibits is a reduction in the materials elastic modulus at high temperatures, meaning the polymer gets less stiff and is more easily deformed (stretched, bent, etc.) This Scrub Daddy material design in dog toys allows the squeaker to perform as required but with increased flexibility and deformability enabling it (once heated to body temperature) and pass through the dog's digestive tract.

The manufacturing and processing of polycaprolactone thermoplastic polyurethane requires lots of components and steps. Since Scrub Daddy uses a patented material exclusive to their company, there is not a lot of specific information on how Scrub Daddy manufactures their products. But since we know the material that the Scrub Daddy is made out of, we can draw a logical conclusion on the steps and raw materials that are required to manufacture and process the sponge.

The material used for the original Scrub Daddy sponge is a polycaprolactone thermoplastic polyurethane foam. Polycaprolactone is a polymer that is used in the production of specialized polyurethanes and is a thermoplastic polymer that changes its structure depending on the temperature it is exposed to http://www.designlife-cycle.com/scrub-daddy-sponge#:^{˜}:text=Polycaprolactone%20is%20a%20polymer%20that,Daddy%20different%20from%20regular%20sponges.

Scrub Daddy likely has additional, proprietary chemistry performed on the PCL material such that it achieves its desired mechanical properties

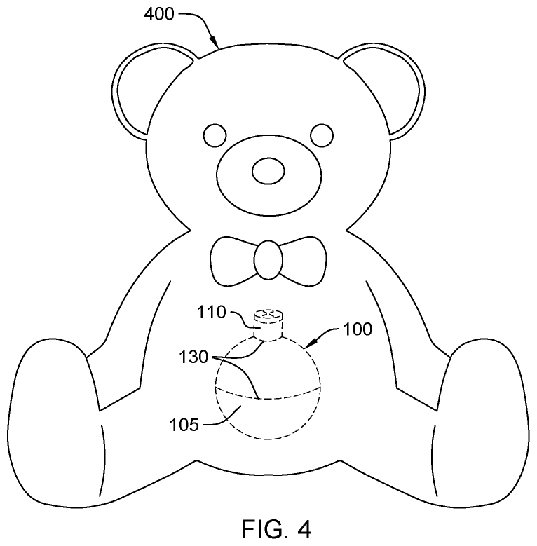

FIG. 4 depicts a teddy bear shaped dog toy 400, which includes a dog squeaker bladder of the invention. In this exemplary embodiment, the dog squeaker bladder is the dog squeaker bladder 100, first depicted in FIG. 1. As shown, the dog squeaker bladder 100 included in the dog toy 400 includes inter alia the body 105, perforated failure points 130 and spout 110. The body 105 is made of body-safe temperature sensitive material that will begin to lose its shape and structural integrity at about 100 degrees Fahrenheit. Hence, once the body is ingested and warms up to the dog's temperature, the frangible pieces are formed when the body separates at the failure points 130, becoming much more pliable and also can collapse and shrink with the movement through the dog's digestive system. The material from which the body is formed also is readily digestible. Please note that the toy 400 is not limited to the squeaker bladder 100 but may include any squeaker bladder formed according to the inventive principles herein.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A squeaker bladder configured for insertion into animal toys to generate a squeak sound when compressed and/or relaxed after compression and configured to be frangible and pliable when contained within a digestive system of an animal that inadvertently consumes the squeaker bladder, or a portion of the squeaker bladder, the squeaker bladder comprising:
a bladder body;
an airport with a squeaker arranged at an opening in the bladder body that allows air into the bladder when the bladder body is relaxed after compression and allows air to pass through the squeaker and out the airport when compressed;
wherein the bladder body is formed from temperature-sensitive material that becomes pliable and/or collapses when subjected to an animal's body temperature upon ingestion to facilitate passing through and out the animal's digestive system.

2. The squeaker bladder of claim 1, shaped spherically.

3. The squeaker bladder of claim 1, shaped cylindrically.

4. The squeaker bladder of claim 1, pill-shaped.

5. The squeaker bladder of claim 1, wherein the airport and squeaker are arranged at a spout arranged at said opening.

6. The squeaker bladder of claim 1, wherein the body includes perforations that can operate as weak points to facilitate separations at the perforations when chewed.

7. The squeaker bladder of claim 1, wherein the animal toy is a dog toy.

8. The squeaker bladder of claim 7, wherein the bladder body includes a coating that tastes terrible to dogs.

9. The squeaker bladder of claim 7, wherein the bladder body includes a coating that is responsive to x-rays to enable tracking the bladder body, or a portion of the bladder body within the dog's digestive track with an x-ray device.

10. The squeaker bladder of claim 1, wherein the bladder body includes pre-formed weakened perforations that facilitate a breakup of the bladder body along the perforations once ingested.

11. The squeaker bladder of claim 1, wherein the temperature-sensitive material facilitates the bladder collapse and passage through the animal's digestive tract.

12. The squeaker bladder of claim 1, wherein the squeaker is a reed element.

13. The squeaker bladder of claim 1, wherein the temperature-sensitive material further includes a coating blend of radiopaque fillers.

14. The squeaker bladder of claim 13, wherein the radiopaque fillers include barium sulfate and/or bismuth.

15. The squeaker bladder of claim 1, wherein the temperature-sensitive material comprises synthetic, oil-derived polyolefin material.

16. The squeaker bladder of claim 1, wherein the temperature-sensitive material comprises any of the group consisting of: polycaprolactone (PCL), polylactic acid (PLA), polyhydroxyalkanoates (PHAs) and polyhydroxy butyrate (PHB).

17. A dog toy configured with a digestible squeaker bladder, the dog toy comprising:
a dog toy body;
a squeaker bladder configured for insertion into the dog toy body to generate a squeak sound when compressed, the squeaker bladder comprising:
a bladder body; and
an airport with a sound-emitting element arranged at an opening in the bladder body that allows air into the bladder when the bladder body is relaxed and allows air to pass through the sound e-emitting element and out the airport when compressed;
wherein the bladder body is formed from temperature-sensitive material that becomes pliable when subjected to a dog's body temperature if ingested so that the bladder body or parts of the bladder body will pass through and out the dog's digestive system.

18. The dog toy of claim 17, wherein the temperature-sensitive material collapses and/or breaks up when subjected to the dog's internal temperature.

19. The squeaker bladder of claim 17, wherein the temperature-sensitive material comprises synthetic, oil-derived polyolefin material.

20. The squeaker bladder of claim 17, wherein the temperature-sensitive material comprises any of the group consisting of: polycaprolactone (PCL), polylactic acid (PLA), polyhydroxyalkanoates (PHAs) and polyhydroxy butyrate (PHB).
